(19) United States
(12) Patent Application Publication
(10) Pub. No.: US 2025/0251549 A1
(43) Pub. Date: Aug. 7, 2025

(54) DENSE PHOTONIC WAVEGUIDE TO OPTICAL FIBER EDGE COUPLING

(71) Applicant: Applied Materials, Inc., Santa Clara, CA (US)

(72) Inventors: Zijiao Yang, Fremont, CA (US); Jinxin Fu, Santa Clara, CA (US); Hans-Juergen Schmidtke, Mountain View, CA (US)

(21) Appl. No.: 19/046,471

(22) Filed: Feb. 5, 2025

Related U.S. Application Data
(60) Provisional application No. 63/550,789, filed on Feb. 7, 2024.

(51) Int. Cl. G02B 6/36; G02B 6/02; G02B 6/293

(52) U.S. Cl. CPC G02B 6/3636; G02B 6/02042; G02B 6/29332; G02B 6/2938; G02B 6/3664

(57) ABSTRACT

A system includes a substrate having a plurality of grooves and a plurality of sets of waveguides formed therein, wherein each groove of the plurality of grooves corresponds to a respective set of waveguides of the plurality of sets of waveguides, and at least one multicore single-mode fiber (MC-SMF) optical fiber secured within at least one respective groove of the plurality of grooves, wherein the at least one MC-SMF optical fiber includes a plurality of inner cores disposed within a cladding layer.

### CROSS-REFERENCE TO RELATED APPLICATION(S)

The present application claims priority to U.S. Provisional Patent Application No. 63/550,789, filed on Feb. 7, 2024 and entitled “DENSE PHOTONIC WAVEGUIDE TO OPTICAL FIBER EDGE COUPLING”, the entire contents of which are hereby incorporated by reference herein.

### TECHNICAL FIELD

Embodiments of the present disclosure relate to optical systems, and more particularly to enabling dense photonic waveguide (“waveguide”) to optical fiber edge coupling.

### BACKGROUND

In an optical system, an optical signal can travel through a waveguide (e.g., optical fiber) that is formed from an inner core made of a first material having a first index of refraction and an outer cladding made of a second material having a second index of refraction less than the first index of refraction. For example, the first material and the second material can each be formed from a different type of glass. Thus, when an optical signal traveling in a waveguide is incident on the boundary between the inner core and the outer cladding at an angle exceeding the critical angle, the optical signal can exhibit total internal reflection. At the boundary, an evanescent wave can be generated from the optical signal. Generally, an evanescent wave is an oscillating wave (e.g., electromagnetic wave or acoustic wave) generated at a boundary between two media and exists only within a very short distance from the boundary. Evanescent waves can exit the waveguide, and their amplitude can decay exponentially as a function of distance from the boundary. Thus, evanescent waves are generally observable in the near field of the optical signal in close proximity to the boundary.

Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling can occur when an evanescent wave generated within a waveguide excites an electromagnetic wave in an adjacent waveguide. Evanescent wave coupling can be accomplished when two waveguides are positioned close together such that the evanescent field generated by one of the waveguides reaches the other waveguide before any substantial decay of the evanescent wave is experienced.

### SUMMARY

In some embodiments, a system includes a substrate having a plurality of grooves and a plurality of sets of waveguides formed therein, wherein each groove of the plurality of grooves corresponds to a respective set of waveguides of the plurality of sets of waveguides, and at least one multicore single-mode fiber (MC-SMF) optical fiber secured within at least one respective groove of the plurality of grooves, wherein the at least one MC-SMF optical fiber includes a plurality of inner cores disposed within a cladding layer.

In some embodiments, a method includes obtaining a substrate having a plurality of grooves and a plurality of sets of waveguides formed therein, wherein each groove of the plurality of grooves corresponds to a respective set of waveguides of the plurality of sets of waveguides, obtaining at least one multicore single-mode fiber (MC-SMF) optical fiber including a plurality of inner cores disposed within a cladding layer, and securing the at least on MC-SMF optical fiber within at least one respective groove of the plurality of grooves.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of a perspective view of at least a portion of a co-packaged substrate having one or more electrical and photonic devices formed thereon, in accordance some embodiments.

FIGS. 2A-2B are diagrams of top views of photonic integrated interconnect units, according to some embodiments.

FIGS. 3-5 are diagrams of cross-sectional views of portions of a photonic integrated interconnect unit, according to some embodiments.

FIG. 6 is a diagram of a cross-sectional view of a portion of a pluggable connector, according to some embodiments.

FIGS. 7A-10C are diagrams of views of a system including a device that can enable dense photonic waveguide (“waveguide”) to optical fiber edge coupling, according to some embodiments.

FIG. 11 is a flowchart of a method to enable dense photonic waveguide (“waveguide”) to optical fiber edge coupling, according to some embodiments.

### DETAILED DESCRIPTION

Embodiments of the present disclosure relate to dense photonic waveguide (“waveguide”) to optical fiber edge coupling. A co-packaged device (e.g., multi-chip module) can include a package substrate having multiple integrated circuit devices assembled closely together. More specifically, optical components can be integrated on substrates (e.g., silicon (Si) substrate) for fabricating large-scale photonics integrated circuits that co-exist with micro-electronic chips. With the use of an optical transceiver, received optical signal can be converted to an electrical signal capable of being processed by an integrated circuit, or the processed electrical signal can be converted to an optical signal to be transmitted via an optical fiber.

A co-packaged device can include an interconnect device (“interconnect”) disposed between a first component and a second component. For example, an interconnect can be a placed between a package substrate and a ball grid array. In some embodiments, an interconnect includes an interposer. An interposer is an electrical interface that routes connections between sockets or connections between the first component and the second component. An interposer can be used to connect components that may not naturally connect to one another.

Coupling of optical fibers to waveguides on a photonic integrated circuit (PIC) can be implemented using an optical fiber connector (“connector”). A connector can be a single-fiber (or simplex-fiber) connector, a duplex-fiber connector, or a multi-fiber connector. Examples of types of connectors include SC (square connector) connectors, FC (ferrule connector) connectors, little or local LC (little connector or local connector) connectors, ST (straight tip) connectors, and MPO (multi-fiber push-on) connectors. One example of an MTO connector is an MTP® (multi-fiber termination push-on) connector.

A connector can include a connection substrate having multiple grooves formed therein, into which multiple respective optical fibers can be inserted and secured. Each optical fiber can be optically coupled to a respective waveguide. A connection substrate can be formed with a geometry that can provide the proper spacing to achieve optical coupling (e.g., evanescent wave coupling). For example, a large number of optical fiber-to-waveguide couplings may be needed for a multi-channel wavelength division multiplexing (WDM) optical system.

One type of a connection substrate is a V-groove connection substrate, which is a substrate having multiple V-grooves formed therein. A V-groove is an opening that has a tapered shape in which the sides of the groove converged to a point (e.g., triangular shape). For each V-groove, an optical fiber can be inserted into the V-groove and secured in the V-groove using an adhesive (e.g., glue).

Some edge coupling solutions utilize single-mode fiber (SMF) to waveguide edge coupling through V-grooves. More specifically, a cladding layer can have a single-mode inner core disposed therein to form a waveguide, which can be placed in a V-groove. Such implementations cannot be densely scaled up due to limitations in cladding layer diameters. Additionally, high-speed interconnects can utilize hundreds of SMFs connected to a PIC. Individually attaching SMFs can consume a large number of spatiotemporal resources.

Waveguide—fiber connection pitch will need to be 127 um for standard SMF or 81 um for reduced cladding SMF. High speed interconnect needs hundreds of SMF to be connected to a single photonic integrated circuit (PIC) Attaching SMF individually takes time and space

Aspects and implementations described herein can address these and other drawbacks by enabling dense waveguide to optical fiber edge coupling. Embodiments described herein can be used to implement multicore single-mode fiber (MC-SMF) to waveguide array edge coupling. An MC-SMF described herein can be connected to multiple standard SMFs with appropriate connector for standard product connection.

A device described herein can include a substrate having multiple grooves (e.g., V-grooves) formed therein. The substrate can further include multiple sets of waveguides. Each set of waveguides can correspond to a respective groove of the substrate. In some embodiments, a pitch corresponding to the distance between adjacent grooves (e.g., distance between points of adjacent V-grooves) ranges between about 100 micrometers (μm) to about 150 μm. In some embodiments, the pitch is about 127 μm. Each groove can receive a respective MC-SMF optical fiber, which can be secured with an adhesive (e.g., glue). An MC-SMF optical fiber can include a cladding layer and multiple inner cores disposed within the cladding layer. Each inner core of an MC-SMF optical fiber disposed in a groove can be optically coupled to a respective waveguide of the corresponding set of waveguides formed within the substrate.

Inner cores can be arranged within a cladding layer using any suitable configuration or geometry. In some embodiments, a cladding layer has a diameter that ranges between about 100 μm to about 150 μm. In some embodiments, a cladding layer has a diameter of about 125 μm.

In some embodiments, inner cores are arranged within a cladding layer in an approximately linear configuration. In some embodiments, an inner core has a diameter that ranges between about 6 μm to about 10 μm. In some embodiments, an inner core has a diameter of about 8 μm. In some embodiments, a distance between each inner core ranges between about 15 μm to about 25 μm. In some embodiments, a distance between each inner core is about 20 μm.

In some embodiments, inner cores are arranged within a cladding layer in a non-linear configuration. For example, the non-linear configuration can have a hexagonal cross-sectional shape. The number of inner cores that can be included in a cladding layer can depend at least in part on the diameter of the cladding layer. In some embodiments, an inner core has a diameter that ranges between about 6 μm to about 10 μm. In some embodiments, an inner core has a diameter of about 8 μm.

In some embodiments, a device includes multiple substrates bonded together (e.g., vertically). More specifically, each substrate can include MC-SMF optical fibers formed in respective grooves, where each MC-SMF optical fiber includes multiple inner cores optically coupled to respective waveguides of a set of waveguides corresponding to the respective groove, similar to the substrate described above. In some embodiments, inner cores are arranged within a cladding layer in a linear configuration. In some embodiments, inner cores are arranged within a cladding layer in a non-linear configuration. For example, the non-linear configuration can have a hexagonal cross-sectional shape. Waveguides from one substrate can be routed to waveguides of another substrate using vias (e.g., through-glass vias (TGVs)), using techniques such as photonic wire bounding, meta-lens, etc.

Embodiments described herein can provide for numerous other technical advantages. For example, embodiments described herein can reduce evanescent wave decay within devices (e.g., interconnects), which can improve the ability of waveguides of these devices to transmit optical signals.

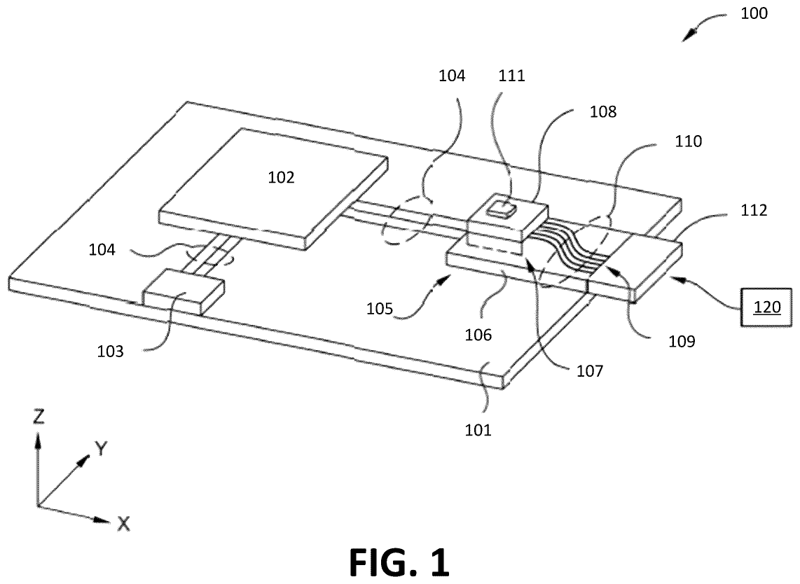

FIG. 1 is a diagram of a perspective view of a system including a co-packaged device 100, in accordance some embodiments. The co-packaged device 100 can include an electrical or opto-electrical chip (“chip”) 102 connected by a waveguides or electrical trace interconnect 104 to a photonic integrated interconnect unit 103 where all are formed on or disposed on a package substrate 101. In some embodiments, the chip 102 includes any high-density chip having a high input/output (I/O) pin count. In one example, the high-density chip has between 100 and 2000 I/O pins or up to and greater than 2000 I/O pin counts. For example, the chip 102 can be a data center SWITCH chips, an artificial intelligence (AI) chip, etc.

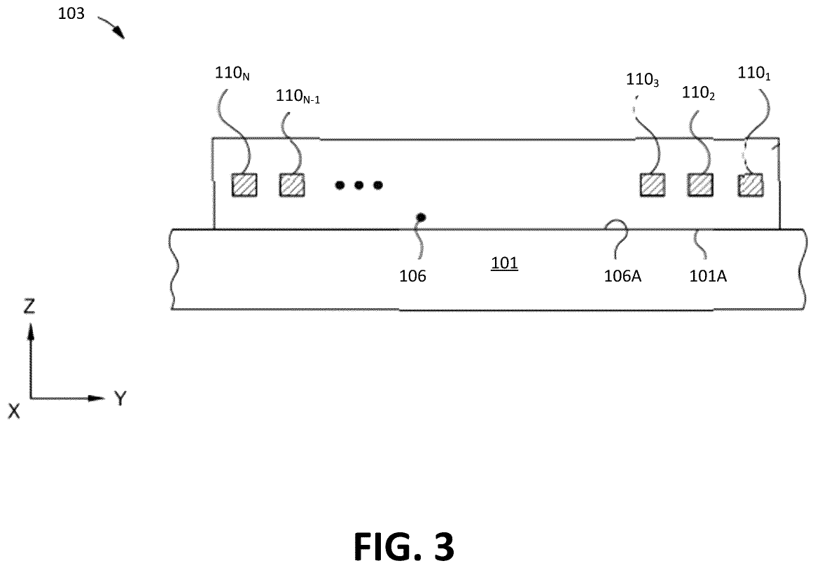

The photonic integrated interconnect unit 103 includes a fiber connector region configured to be coupled to a fiber connector 112 for removably connecting a fiber cable 120 to the photonic integrated interconnect unit 103. In some embodiments, the fiber cable 120 is plugged into the fiber connector 112 to operably connect the fiber cable 120 to the co-packaged device 100. In an embodiment, the photonic integrated interconnect unit 103 is configured for connecting fiber cables 120 including, but not limited to, single-mode fiber optic cables having 9 μm fiber core diameters. The fiber connector 112 may further include optical fibers 112A (FIG. 4) to operably connect fiber cables 120 having between 1 to 74 fiber cores, 74 to 148 fiber cores, and up to and greater than 148 fiber cores to the photonic integrated interconnect unit 103.

In some embodiments, the photonic integrated interconnect unit 103 is configured to transmit signals between the chip 102 and the fiber cable 120 connected to the photonic integrated interconnect unit 103. The photonic integrated interconnect unit 103 includes a photonic glass layer (PGL) substrate 106, optical structures 110₁-110_{N} formed integral with or on the PGL substrate 106, an optical transceiver integrated circuit (chip) 108 mounted on the PGL substrate 106 and coupled to the optical structures 110₁-110_{N} at a first interface 107, and the fiber connector 112 connected to both the PGL substrate 106 and the optical structures 110₁-110_{N} at a second interface 109.

The chip 108 operates to convert electrical signals to optical signals, and vice versa. In some embodiments, the chip 108 is a silicon photonic (SiPho) chip. The optical structures 110₁-110_{N} operate to transmit optical signals between the chip 108 and the fiber connector 112, and the optical waveguide or electrical trace interconnect 104 operate to transmit electrical or optical signals between the photonic integrated interconnect unit 103 (e.g., the chip 108) and the chip 102. The optical waveguide or electrical trace interconnect 104 can include metal traces that are formed within the package substrate 101, which in some embodiments can include metal traces formed in a printed circuit board (PCB) substrate or metal traces formed within multiple redistribution layers (e.g., dielectric containing layers) formed over a solid core substrate (e.g., silicon or glass core substrate).

A photonic engine 105 may optionally further include one or more electronic phy chips 111 that are coupled to the chip 108. The electronic phy chip 111 is generally used to assist with operations performed by an optical chip. In some embodiments, the electronic phy chip 111 is operably connected to the chip 108 to assist the chip 108 with various electrical functions. As shown, the electronic phy chips 111 may be mounted on top of the chip 108 and thereby directly connected to the chip 108. Alternatively, the electronic phy chip 111 may be embedded in the PGL substrate 106 and connected to the chip 108 through the PGL substrate 106, which is often simply referred to herein as a substrate 106. Further, the electronic phy chip 111 can be mounted on or embedded in the package substrate 101 and connected to the chip 108 through electrical interconnect 104.

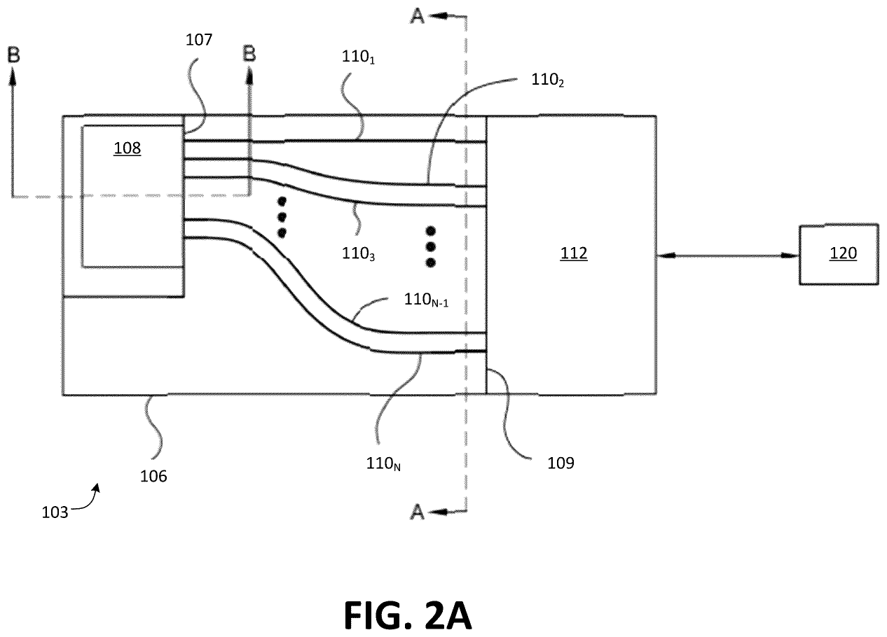

FIGS. 2A-2B are diagrams of top views of the photonic engine 105, according to some embodiments. As shown in FIG. 2A, the photonic engine 103 includes the chip 108 mounted near one end of the PGL substrate 106, the fiber connector 112 connected at an opposite end of the PGL substrate 106 from the chip 108, and the optical structures 110₁-110_{N} extending between the chip 108 and the fiber connector 112. In some embodiments, each of the optical structures 110₁-110_{N} include a light transmitting region for transmitting light in either direction between the first interface 107 and the second interface 109. The light being transmitted through the optical structures can be either received from one or more waveguides 108A (FIG. 2B) of the chip 108 or received from one or more optical fibers within the fiber connector 112 that a light signal source is in communication with during use. The chip 108 is typically configured to receive light (e.g., detect) transmitted through the optical structures 110₁-110_{N} and also emit light (e.g., transmit) into the optical structures 110₁-110_{N} in an effort to communicate with external devices connected through the fiber connector 112. The chip 108 can be configured to transmit light into the optical structures 110₁-110_{N} by at least the use of light emitters integrated into chip 108, or by use of light emitters that are external to PGL substrate 106. In the case where the light emitters are external to PGL substrate 106 the light is delivered to chip 108 via the optical structures 110₁-110_{N} and then modulated by the chip 108 to create a transmit signal that is provided to the optical structures 110₁-110_{N}. In some embodiments, which can be combined with other embodiments described herein, the optical structures 110₁-110_{N} are formed on (e.g. directly or indirectly) or are integral with the PGL substrate 106.

In some embodiments, which can be combined with other embodiments described herein, the light transmitting region within each of the optical structures 110₁-110_{N} may have the same cross-sectional dimensions, such as height and width. In another embodiment, which can be combined with other embodiments described herein, the light transmitting region within at least one of the optical structures 110₁-110_{N} may have at least one different cross-sectional dimensions, such as one of height and width, from the dimensions of the other optical structures 110 within the PGL substrate 106. In one embodiment, which can be combined with other embodiments described herein, the light transmitting region within each of the optical structures 110₁-110_{N} may have the same refractive index. In another embodiment, which can be combined with other embodiments described herein, the light transmitting region within at least one of the optical structures 110₁-110_{N} may have a different refractive index or multiple different refractive indexes or a gradual gradation of refractive indexes or other index varying structures when compared with the rest of the optical structures 110₁-110_{N} within the PGL substrate 106.

In some embodiments, the number of optical structures 110₁-110_{N} formed in the PGL substrate 106 is dependent on the number of waveguides 108A in the chip 108 needing to be connected, which may also correspond with the number of fiber connections to be connected to the chip 102. In some embodiments, the chip 102 may comprise seventy-two (72) fiber connections such that seventy-two (72) corresponding interconnects 104 extend from the chip 102 and connect to seventy-two (72) corresponding fibers and waveguides 108A in the chip 108 of the photonic engine 105. To appropriately connect the chip 108 to the fiber connector 112 via the optical structures 110₁-110_{N} in the photonic glass layer substrate 106, seventy-two (72) corresponding optical structures 110 are formed on or integral with the PGL substrate 106. In this example, as shown in FIGS. 2A-2B, N equals 72, and thus the optical structures 110 are spaced apart in the X-Y plane from one edge of the PGL substrate 106 to the other edge of the PGL substrate 106. In this example, optical structure 1101 is positioned near the top-most edge and optical structure 110₇₂ would be positioned closest to the bottom most edge of FIG. 2A. As discussed further below, the optical structures 110₁-110_{N} are spaced apart and separated by a material that has different optical properties, such as index of refraction (n), than the light transmitting portions of the optical structures 110₁-110_{N}.

The optical structures 110₁-110_{N} are generally sized and configured to appropriately connect to the waveguides 108A within the chip 108. In an embodiment, the waveguides 108A (FIG. 2B) at the output of the chip 108, or portion that is to communicate with the optical structures, have a core with a height dimension that is about 1 μm in cross-sectional size. In one configuration, the output of the chip 108 has a square or rectangular shaped cross-section that has at least one dimension that is equal to about 1 μm in length. For example, a square cross-section of a waveguide 108A may have a core that is 1 μm height and width. Light transmitted to and from the chip 108 would thus be transferred through the 1 μm waveguides 108A.

In contrast, light transmitted to and from the fiber cable 120 through the fiber connector 112 can have a different form factor, such as having a core cross sectional dimension of about 9 μm in size. For example, the fiber connector 112 may have a square, rectangular or circular cross-section with a core having a height dimension that is about 9 μm in size. As such, in some embodiments, each of the optical structures 110₁-110_{N} is formed such that light propagating through the optical structures 110₁-110_{N} between the chip 108 and the fiber cable 120 is expanded or compressed accordingly depending on the direction of propagation of the optical signal. In one example, the optical structures 110₁-110_{N} extending from the second interface 109 adjacent to the 9 μm fibers in the fiber connector 112 have transmission regions with cross-sectional areas that vary at different portions of the respective structures to facilitate coupling to the 1 μm waveguides 108A in the chip 108. In one embodiment, the optical structures 110₁-110_{N} are tapered along at least a portion of their length from a 9 μm dimensional core size until they are near 1 μm dimensional core size near the first interface 107, where it is assumed that the varying dimensional core size relates to a dimension of a side of a square or rectangular cross-sectional shaped optical structure 110. In some embodiments, the tapered optical structures 110 have a cross-sectional area ratio, which if measured at one end versus measured at the opposing end of the optical structure 110 is greater that 1:1 and less than about 1:100, or less than 1:81. In some embodiments, the optical structures 110₁-110_{N} extending from the second interface 109 adjacent to the fiber connector 112 have a varying refractive index along at least a portion of their length from the second interface 109 to the first interface 107 to facilitate coupling between the optical elements within the chip 108 and the fiber connector 112 that have different cross-sectional dimensions.

In another aspect, the photonic engine 105 is configured such that the transmission loss of the optical signal between the first interface 107 and the second interface 109 is approximately or less than 3 dB, inclusive of loss due to the transmission of the optical signal through the optical structures 110₁-110_{N} themselves. In some embodiments, the transmission loss may largely be dependent on the coupling at the first interface 107 between the chip 108 and the optical structures 110₁-110_{N}. As shown in FIG. 2B, in an embodiment, the chip 108 is to be mounted on a coupling surface 208 at a chip mounting region 204 of the PGL substrate 106. When mounted on chip mounting region 204, the waveguides 108A disposed on the side surface 108B of the chip 108 are aligned with the optical structures 110₁-110_{N} found at the first interface 107.

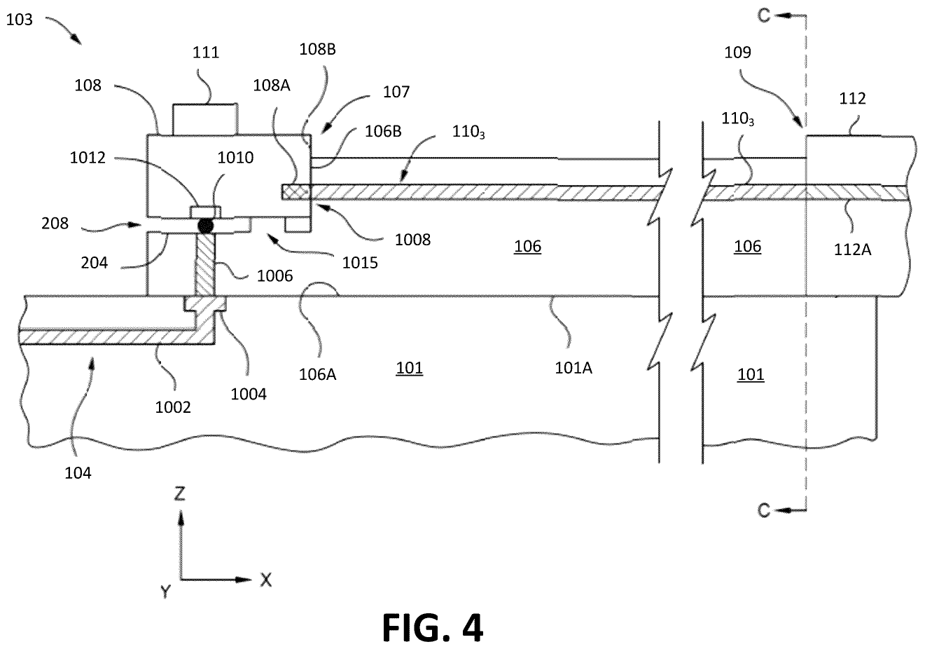

In some embodiments, the PGL substrate 106 further includes one or more fiducial marks 206 to assist in the alignment and mounting of the chip 108 on the chip mounting region 204. The one or more fiducial marks 206 operate to guide and help align the position of the chip 108 along the X-Y plane of the PGL substrate 106 to ensure mounting of the chip 108 occurs with proper alignment to one or more electrical contacts (e.g., vias 1006) and optical structure portions of the PGL substrate 106. As such, in an embodiment, the tolerance for error in the coupling or hybrid bonding the chip 108 and the optical structures 110₁-110_{N} together at the first interface 107, which will be discussed further below, may be in a range from 0.1 to 2 μms to ensure the connections are optimized for the lowest signal loss. In one embodiment, the misalignment of the centers of the waveguides 108A and the optical structures 110₁-110_{N} is maintained such that the lateral misalignment in the Y-direction (i.e., top to bottom direction in FIG. 2B) is less than 1 to 2 μms. In some embodiments, the misalignment of the centers of the waveguides 108A and the optical structures 110₁-110_{N} is also maintained such that the vertical misalignment in the Z-direction (FIGS. 4-5) is less than 1 to 2 μms. In one embodiment, the variability in the vertical misalignment can be dependent on the variability of the compression of solder balls 1011 or other electrical contact that is used to electrically couple the chip 108 to vias 1006 (shown in FIGS. 4-5) formed in a portion of the PGL substrate 106.

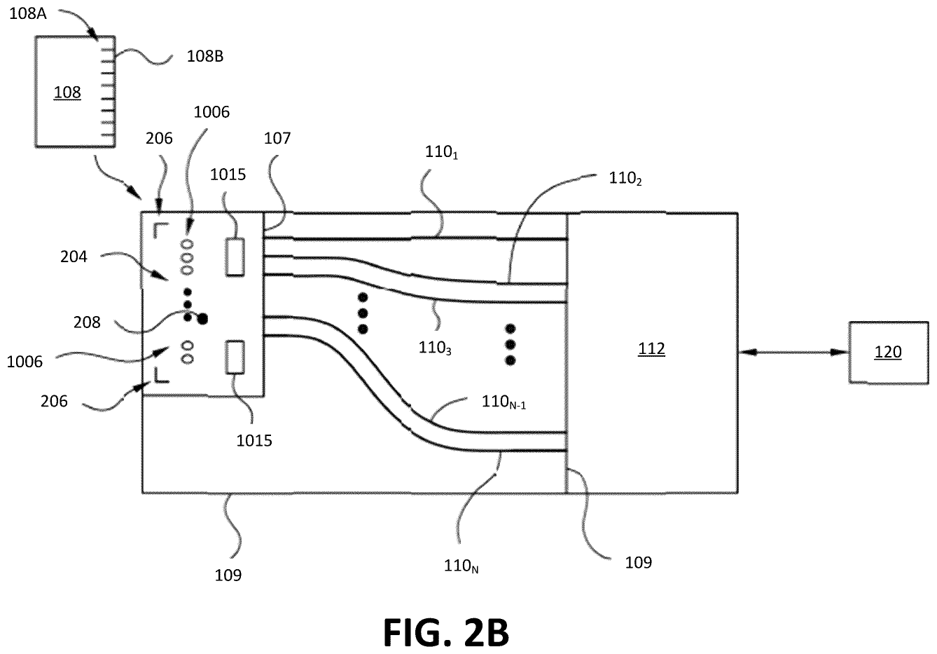

FIG. 3 is a diagram of a schematic, cross-sectional end view of a portion of the photonic engine 105 mounted on the package substrate 101 formed by use of the sectioning line C-C in FIG. 4., according to some embodiments. As shown in FIG. 3, the photonic engine 105 includes a bottom surface 106A of the photonic glass layer substrate 106 disposed on a top surface 101A of the package substrate 101, with the optical structures 110₁-110_{N} extending through the PGL substrate 106. As shown, the optical structures 110₁-110_{N} extending through the PGL substrate 106 are each aligned in the X-Z plane of the PGL substrate 106. While FIG. 3 shows the optical structures 110₁-110_{N} formed in a single row in plane across the PGL substrate 106, other arrangements of the optical structures 110₁-110_{N} may be formed in the PGL substrate 106. For example, more than a single row of optical structures may be formed and stacked vertically. The arrangements of the optical structures 110₁-110_{N} is not intended to limit the scope of the disclosure provided herein.

FIG. 4 is a schematic, transverse cross-sectional lateral view of a portion of the photonic engine 105 mounted on the package substrate 101 that is formed by use of the sectioning line B-B in FIG. 2A, according to some embodiments. As shown in FIG. 4, the package substrate 101 includes circuit traces 1002 extending from interconnect pads 1004 formed integral in the top surface 101A of package substrate 101. In some embodiments, the circuit traces 1002 form the interconnects 104 that electrically connect the photonic engine 105 in contact with the interconnect pads 1004 to the chip 102. Alternatively, the circuit traces 1002 may electrically connect the photonic engine 105 in contact with the interconnect pads 1004 to other integrated circuits disposed on the package substrate 101.

In some embodiments, the vias 1006 extend through a portion of the PGL substrate 106 between the coupling surface 208 and the bottom surface 106A of the PGL substrate 106. When the photonic engine 105 is mounted to the package substrate 101, the vias 1006 can be aligned with and placed in electrical contact with the corresponding interconnect pads 1004 that are exposed on the top surface 101A of package substrate 101 and are in electrical connection with the photonic integrated interconnect unit 103 through the circuit traces 1002 formed in the package substrate 101. In some embodiments, the vias 1006 alternatively connect the photonic engine 105 to one or more other integrated circuits (chips) embedded in the package substrate 101 or on the package substrate 101.

As shown in FIG. 4, the chip 108 can be actively or passively mounted on the coupling surface 208 of the PGL substrate 106 with the side surface 108B of the chip 108 are “butt-coupled” to an end surface 106B of the PGL substrate 106 at the first interface 107. When the chip 108 is butt-coupled to the end surface 106B of the PGL substrate 106, the end of the waveguide 108A in the chip 108 is also butt-coupled to a corresponding end of the optical structure 110, such as optical structure 1103, formed in the PGL substrate 106 at a fourth coupling interface 1008. The coupling of the waveguides 108A to the optical structures 110 at the fourth interface 1008 can impact the loss of optical signals between the chip 108 and the PGL substrate 106. As such, to minimize coupling loss, the aforementioned one or more fiducial marks 206 (FIG. 2B) are used during mounting of the chip 108 to assist in alignment and the precise placement of the chip 108 to optimize the butt-coupling of the waveguides 108A and the optical structures 110₁-110_{N} at the fourth interface 1008 and minimize coupling loss.

To connect the chip 108 to the PGL substrate 106, chip 108 further includes solder connects 1012 that are in contact with the solder balls 1011, wherein the solder balls 1011 are positioned between the solder connects 1012 and an end of each of the vias 1006 on the coupling surface 208. The solder balls 1011 electrically connect the chip 108 to the vias 1006 formed in the photonic glass layer substrate 106. In some embodiments, the solder balls or other interconnect bumps, pillars or interconnect materials, including planar hybrid bonding techniques, 1010 are used to connect the solder connects 1012 to the vias 1006 extending through the PGL substrate 106 to the package substrate 101. In the embodiment shown, the solder balls 1011 and the vias 1006 connect the solder connects 1012 to the plurality of interconnect pads 1004 in the package substrate 101, thereby electrically connecting the chip 108 to the circuit traces 1002 in the package substrate 101 connected to the plurality of interconnect pads 1004.

In some embodiments, the coupling surface 208 of the PGL substrate 106 further includes a plurality of recesses (not shown) for cradling each of the solder balls 1011 used to connect the solder connects 1012 in the chip 108 and the vias 1006 in the PGL substrate 106. The recesses may be formed to allow for expansion of the solder balls 1011 when flattened such that the contacting surface of the solder balls 1011 may be substantially flush with the coupling surface 208. The flattening of the solder balls 1011 on the coupling surface 208 when contacting the solder connects 1012 in the chip 108 helps ensure uniformity in the mounting of the chip 108 on the PGL substrate 106 as well as increases contact reliability of the solder balls 1011.

FIG. 4 also includes a cross-sectional view of a portion of the fiber connector 112 that is coupled to a portion of the PGL substrate 106 at the interface 109, according to some embodiments. The fiber connector 112 can be removably connected to a portion of the photonic engine 105 to allow the transmission to and receipt of optical signals from the optical structures 110 by use of a “butt-coupled” connection configuration.

FIG. 5 is a schematic, cross-sectional lateral view of a portion of the photonic engine 105 mounted on the package substrate 101, according to some embodiments. As shown, the chip 108 may be passively mounted on the photonic glass layer substrate 106 in a second chip mounting region 1106 of the photonic glass layer substrate 106. The second chip mounting region 1106 of the PGL substrate 106 further includes a coupling portion 1102 of each of the optical structures 110₁-110_{N} extending along a coupling surface 1104 of the PGL substrate 106. When the chip 108 is mounted on the second chip mounting region 1106, a portion of the waveguides 108A in the chip 108 are evanescently coupled with a surface of the corresponding coupling portions 1102 of each of the optical structures 110₁-110_{N} in the PGL substrate 106. The evanescent wave coupling of the waveguides 108A to the optical structures 110 allow for optical signals to be transferred between the coupled waveguides.

In some embodiments, the evanescently coupling of the waveguides may be formed as a directional coupler wherein the evanescent modes of one waveguide overlap with the modes of a second waveguide. When the evanescent modes of the waveguides overlap, evanescent fields generated by the respective waveguides also overlap such that the evanescent field generated by one waveguide may excite a wave in the other waveguide. As such, in one aspect, the coupling strength between the waveguides 108A and the optical structures 110 may therefore be sensitive to the distance between the waveguides 108A and optical structures 110, and/or the length of the coupling portion 1102. The coupling portion 901 and respective contacting portion of the waveguides 108A may therefore be sized and formed to optimize the coupling and minimize coupling loss.

The mounting of the chip 108 on the substrate 106 in the chip mounting region 1106 of the substrate 106 further includes connecting the solder connects 1012 in the chip 108 to the vias 1006 in the PGL substrate 106 using the solder balls 1011. The solder balls 1011 may be positioned on the coupling surface 208 adjacent to the coupling portions 1102 of the optical structures 110₁-110_{N} and aligned between each respective solder connects 1012 and via 1006. The solder balls 1011 may be sized such that when the solder balls 1011 is flattened due to the contact of the chip 108 being mounted on the PGL substrate 106, the solder balls 1011 is flattened to a height substantially the same as the height of the coupling portions 1102 of the optical structures 110₁-110_{N}. In the embodiment shown, the solder balls 1011 in contact with the vias 1006 and the interconnect pads 1004 electrically connect the chip 108 to the circuit traces 1002 in the package substrate 101. Further, one or more stand-off structures 1015 can be used to position, support and/or help align the chip 108 within the chip mounting region 204. In one example, the stand-off structures 1015 (FIG. 4) are formed to help set the vertical alignment of the waveguides 108A with the optical structures 110. In some embodiments, the PGL substrate 106 includes one or more stand-off structures 1015 that are configured to support the chip 108 in a direction (e.g., Z-direction) that is substantially perpendicular to a plane that is parallel to the plane in which the optical structures 110₁-110_{N} extend (e.g., X-Y-plane).

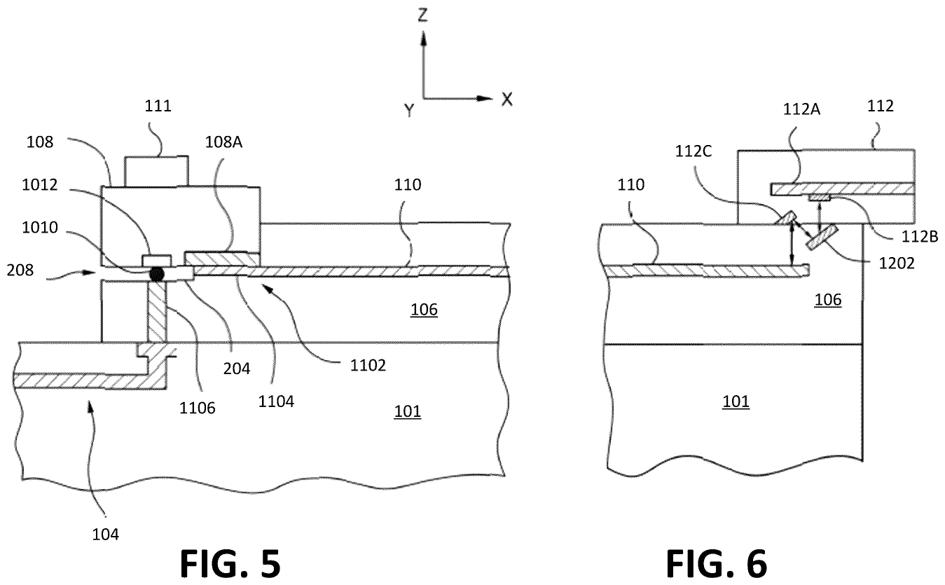

FIG. 6 is a schematic, cross-sectional lateral view of the fiber connector 112 portion of the photonic engine 105, according to some embodiments. In general, the fiber connector 112 is used to removably connect the external fiber cable 120 to the photonic engine 105. The optical fibers 112A of the fiber connector 112 transmit light signals to and from the fiber cable 120 plugged into the fiber connector 112. The fiber connector 112 is configured to allow for the attachment of external fiber cable 120 to the optical input/output of the photonic engine 105 without requiring active alignment of the fiber cable 120 to the photonic engine 105 on a per fiber core basis. As such, the fiber connector 120 may be formed and configured to be interoperable with a variety of different fiber cable 120 assemblies and standards. Light transmitted along the fibers 112A is directed to the optical structures 110₁-110_{N} on the PGL substrate 106 by a lens assembly for subsequent transmittance to and through the photonic engine 105. The lens assembly includes a first lens 112B and a third lens 112C formed on the fiber connector 112, and a second lens 1202 formed on the substrate 106. As shown, light from the fiber cable 120 is transmitted along the fiber 112A towards the first lens 112B formed near the end of the fiber 112A. The first lens 112B directs light transmitted along the fiber 112A towards the second lens 1202 on the PGL substrate 106. The second lens 1202 on the PGL substrate 106 then reflects and re-direct the light back towards the third lens 112C on the fiber connector 112. The third lens 112C finally reflects and re-directs the light to the optical structures 110 on the PGL substrate 106 for subsequent transmittance through the photonic engine 105.

FIGS. 1-6 have described optical photonic devices having multiple optical structures formed on a substrate (e.g., glass substrate). The optical photonic device can include a photonic chip mounted on the photonic substrate and connected to multiple optical structures. The optical structures optically connect the photonic chip to a fiber connector configured to connect with an external fiber and operate to propagate light signals between the fiber connector and the photonic chip.

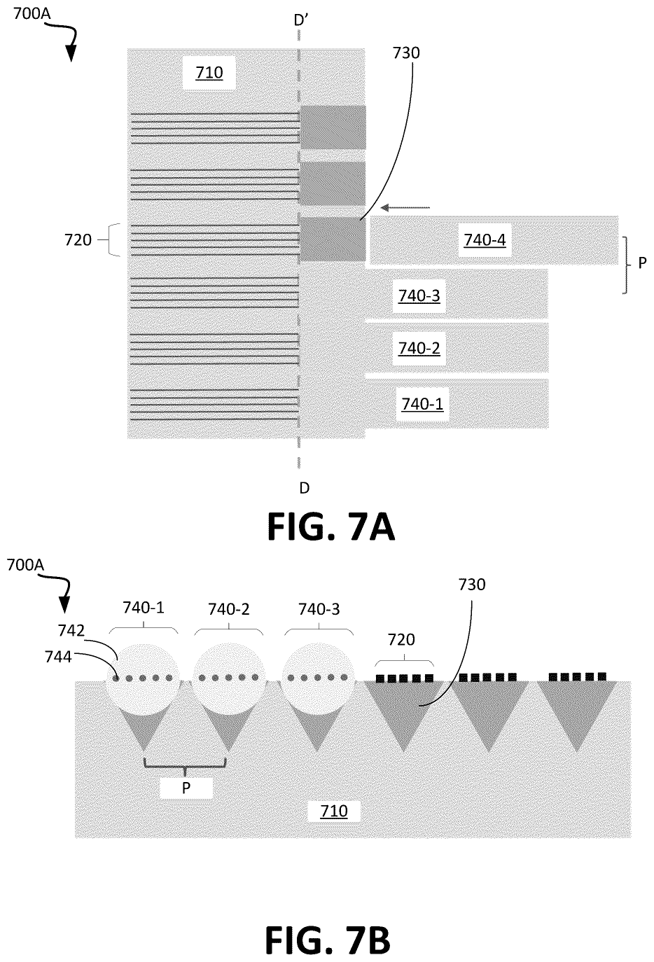

FIGS. 7A-7B are diagrams of views of an apparatus or system 700, according to some embodiments. More specifically, FIG. 7A is a top-down view of the system 700, and FIG. 7B is a cross-sectional view of the system 700 through line D-D′.

As shown in FIGS. 7A-7B, system 700 can include substrate 710, multiple sets of waveguides including set of waveguides 720 formed within substrate 710, and multiple grooves including groove 730 formed within substrate 710. In some embodiments, and as shown, groove 730 is a V-groove. Each set of waveguides can correspond to a respective groove (e.g., set of waveguides 720 corresponds to groove 730).

As further shown in FIGS. 7A-7B, system 700 can include multiple MC-SMF optical fibers including optical fibers 740-1 through 740-4. Each groove can receive a respective optical fiber, which can be secured with an adhesive (e.g., glue). For example, groove 730 can receive optical fiber 740-4. Each optical fiber can include a cladding layer and multiple inner cores disposed within the cladding layer. More specifically, each inner core can be a single-mode core. For example, optical fiber 740-1 includes cladding layer 742 and inner cores 744. Inner cores 744 can be arranged within cladding layer 742 using any suitable configuration or geometry. In these illustrative embodiments, inner cores 744 are arranged within cladding layer 742 in an approximately linear configuration. Each inner core 744 can be optically coupled to a respective waveguide of the corresponding set of waveguides.

The number of inner cores 744 that can be included in cladding layer 742 can depend at least in part on the diameter of the cladding layer 742 and the diameter of each inner core 744. In some embodiments, cladding layer 742 has a diameter that ranges between about 100 μm to about 150 μm. In some embodiments, cladding layer 742 has a diameter of about 125 μm. In these illustrative embodiments, each set of waveguides includes five waveguides and each optical fiber includes five inner cores. However, such an example should not be considered limiting. In some embodiments, up to seven inner cores can be linearly arranged within a cladding layer of an MC-SMF optical fiber.

In some embodiments, each inner core 744 has a diameter that ranges between about 6 μm to about 10 μm. In some embodiments, each inner core 744 has a diameter of about 8 μm. In some embodiments, a distance between each inner core 744 ranges between about 15 μm to about 25 μm. In some embodiments, a distance between each inner core 744 is about 20 μm.

In some embodiments, a pitch “P” corresponding to the distance between adjacent grooves (e.g., distance between points of adjacent V-grooves) ranges between about 100 μm to about 150 μm. In some embodiments, the pitch is about 127 μm. An effective pitch is defined as a ratio between the pitch and the number of inner cores within the pitch. For example, if the pitch is about 127 μm and the number of inner cores is five, then the effective pitch is about 25.4 μm.

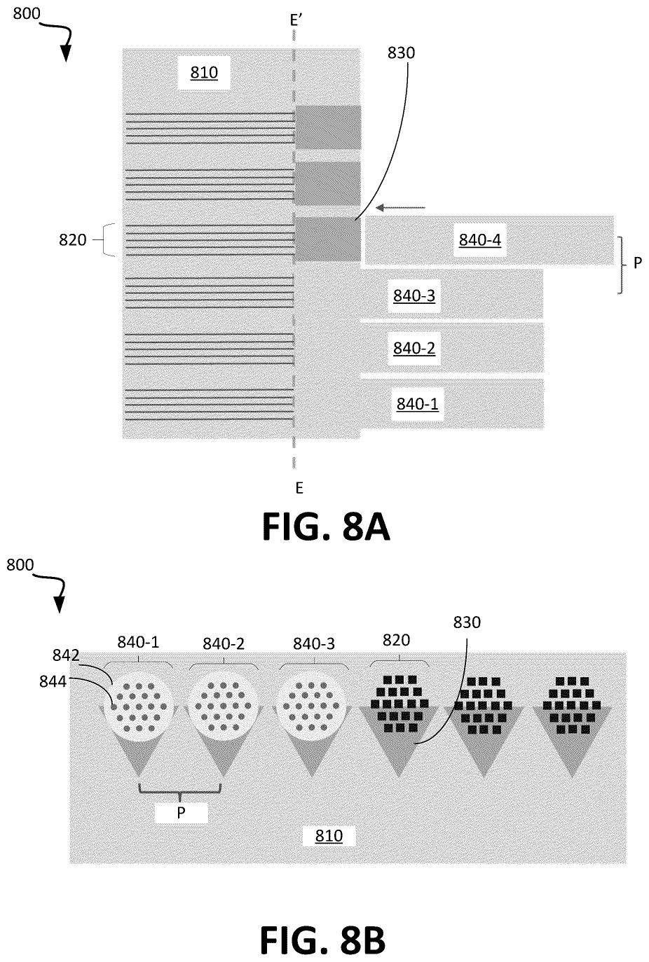

FIGS. 8A-8B are diagrams of views of an apparatus or system 800, according to some embodiments. More specifically, FIG. 8A is a top-down view of the system 800, and FIG. 8B is a cross-sectional view of the system 800 through line E-E′.

As shown in FIGS. 8A-8B, system 800 can include substrate 810, multiple sets of waveguides including set of waveguides 820 formed within substrate 810, and multiple grooves including groove 830 formed within substrate 810. In some embodiments, and as shown, groove 830 is a V-groove. Each set of waveguides can correspond to a respective groove (e.g., set of waveguides 820 corresponds to groove 830).

As further shown in FIGS. 8A-8B, system 800 can include multiple MC-SMF optical fibers including optical fibers 840-1 through 840-4. Each groove can receive a respective optical fiber, which can be secured with an adhesive (e.g., glue). For example, groove 830 can receive optical fiber 840-4. Each optical fiber can include a cladding layer and multiple inner cores disposed within the cladding layer. More specifically, each inner core can be a single-mode core. For example, optical fiber 840-1 includes cladding layer 842 and inner cores 844. Inner cores 844 can be arranged within cladding layer 842 using any suitable configuration or geometry. In these illustrative embodiments, inner cores 844 are arranged within cladding layer 842 in a non-linear configuration. For example, the non-linear configuration can have a hexagonal cross-sectional shape. Each inner core 844 can be optically coupled to a respective waveguide of the corresponding set of waveguides.

The number of inner cores 844 that can be included in cladding layer 842 can depend at least in part on the diameter of the cladding layer 842. In some embodiments, cladding layer 842 has a diameter that ranges between about 100 μm to about 150 μm. In some embodiments, cladding layer 842 has a diameter of about 125 μm. In these illustrative embodiments, each set of waveguides includes 19 waveguides and each optical fiber includes 19 inner cores. However, such an example should not be considered limiting. In some embodiments, up to 32 inner cores can be non-linearly arranged within a cladding layer of an MC-SMF optical fiber. In some embodiments, each inner core 844 has a diameter that ranges between about 6 μm to about 10 μm. In some embodiments, each inner core 844 has a diameter of about 8 μm.

In some embodiments, a pitch “P” corresponding to the distance between adjacent grooves (e.g., distance between points of adjacent V-grooves) ranges between about 100 μm to about 150 μm. In some embodiments, the pitch is about 127 μm. As previously mentioned above with reference to FIGS. 7A-7B, an effective pitch is defined as a ratio between the pitch and the number of inner cores within the pitch. For example, if the pitch is about 127 μm and the number of inner cores is 19, then the effective pitch is about 6.7 μm. Accordingly, arranging multiple inner cores in a non-linear configuration can increase the number of inner cores within the optical fiber, which enable a smaller effective pitch as compared to the linear configuration example shown in FIGS. 7A-7B.

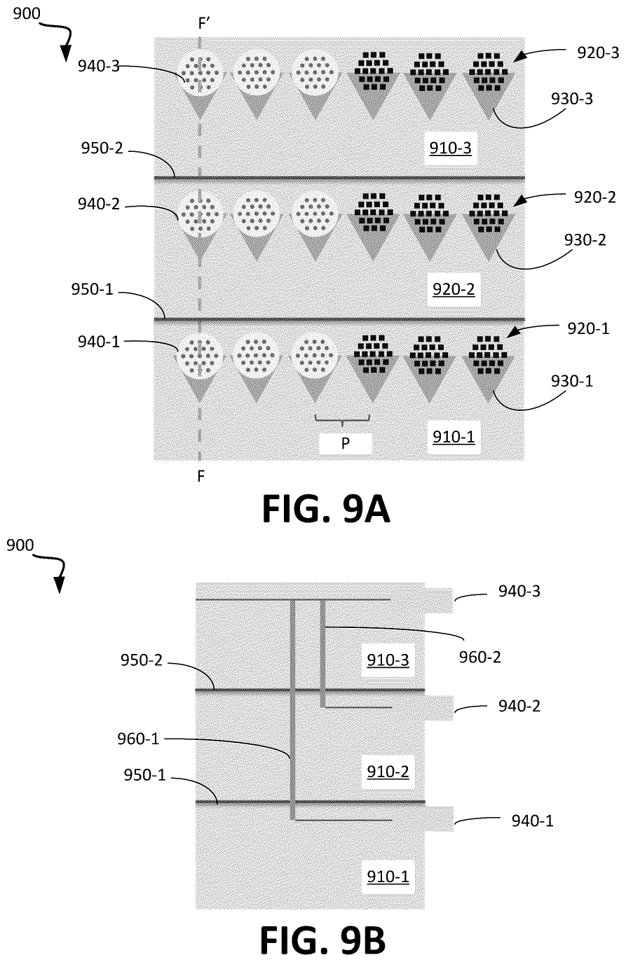

FIGS. 9A-9B are diagrams of views of an apparatus or system 900, according to some embodiments. More specifically, FIG. 9A is a cross-section view of the system 900, and FIG. 9B is a side view of the system 800 through line F-F′.

As shown in FIG. 9A, system 900 can include multiple substrates including substrates 910-1 through 910-3. Substrate 910-1 can include multiple sets of waveguides including set of waveguides 920-1 formed therein, and multiple grooves including groove 930-1 formed therein. Each groove of substrate 910-1 can receive a respective MC-SMF optical fiber (e.g., optical fiber 940-1), which can be secured with an adhesive (e.g., glue). Substrate 910-2 can include multiple sets of waveguides including set of waveguides 920-2 formed therein, and multiple grooves including groove 930-2 formed therein. Substrate 910-3 can include multiple sets of waveguides including set of waveguides 920-3 formed therein, and multiple grooves including groove 930-3 formed therein. Each groove of substrate 910-2 can receive a respective optical fiber (e.g., optical fiber 940-2), which can be secured with an adhesive (e.g., glue). Each groove of substrate 910-3 can receive a respective optical fiber (e.g., optical fiber 940-3), which can be secured with an adhesive (e.g., glue). Substrate 910-1 can be bonded to substrate 910-2 via bonding layer 950-1 and substrate 910-2 can be bonded to substrate 910-3 via bonding layer 950-2. In some embodiments, each groove is a V-groove. Each set of waveguides can correspond to a respective groove (e.g., set of waveguides 820 corresponds to groove 830). Each optical fiber can include a cladding layer and multiple inner cores disposed within the cladding layer. More specifically, each inner core can be a single-mode core. As shown in these illustrative embodiments, optical fiber 940-1 through 940-3 are similar to optical fibers 840-1 through 840-3 described above with reference to FIGS. 8A-8B (e.g., inner cores arranged within cladding layers in a non-linear configuration). However, such embodiments should not be considered limiting. In some embodiments, a pitch “P” corresponding to the distance between adjacent grooves (e.g., distance between points of adjacent V-grooves) ranges between about 100 μm to about 150 μm. In some embodiments, the pitch is about 127 μm (e.g., between about 2-3 μm effective, as compared to about 25 μm effective). Accordingly, bonding multiple substrates together can enable a smaller effective pitch as compared to the single substrate examples shown in FIGS. 7A-7B and FIGS. 8A-8B.

As further shown in FIG. 9B, multiple vias including vias 960-1 and 960-2 can be formed to route waveguides from one of substrates 910-1 through 910-3 to another one of substrate 910-1 through 910-3 with techniques such as photonic wire bonding, meta-lens, etc. In some embodiments, a via is a TGV.

An effective pitch for a system described herein can be determined based on a ratio between the pitch between grooves and the number of inner cores in an optical fiber. For example, in FIGS. 7A-7B, the effective pitch can be determined as the ratio of the pitch P and the number of inner cores in an optical fiber. Illustratively, if the pitch is 127 μm and the number of inner cores in optical fiber 740-1 is five, then the effective pitch is a about 25.4 μm. As another example, in FIGS. 8A-8B, the effective pitch can be determined as the ratio of the pitch P and the number of inner cores in an optical fiber. Illustratively, if the pitch is 127 μm and the number of inner cores in optical fiber 840-1 is 19, then the effective pitch is a about 6.7 μm. As yet another example, in FIGS. 9A-9B, the effective pitch can be determined as the ratio of the pitch P and the number of inner cores in an optical fiber, divided by the number of substrates. Illustratively, if the pitch is 127 μm and the number of inner cores in optical fiber 940-1 is 19, then the effective pitch is about 2.2 μm.

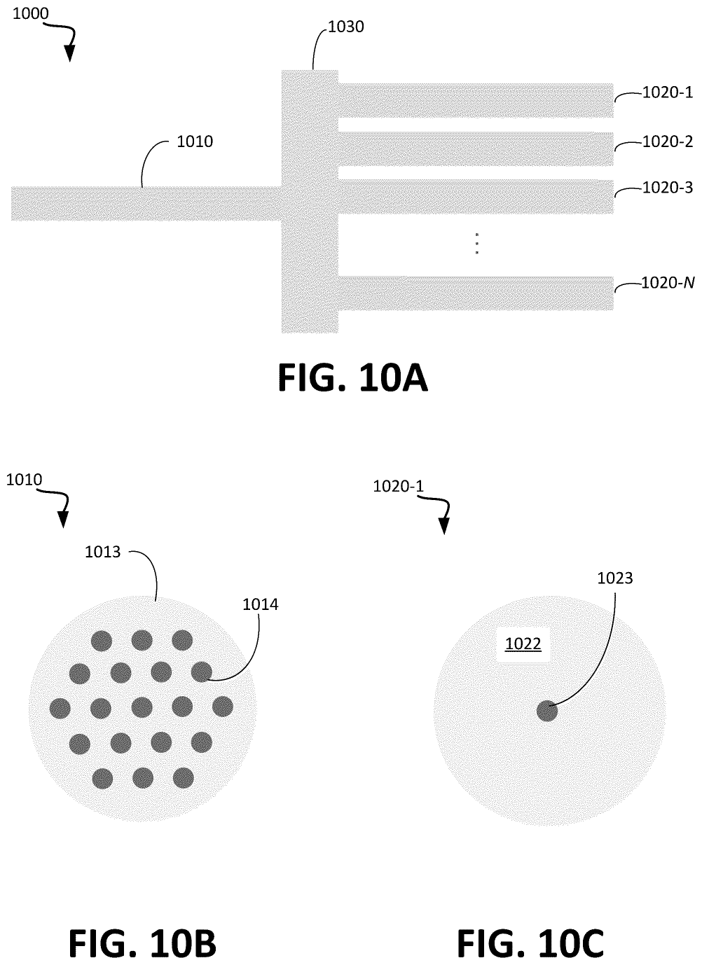

FIG. 10A is a diagram of a system 1000 enabling an MC-SMF to SMF connection, according to some embodiments. As shown, system 1000 can include MC-SMF optical fiber 1010 and multiple SMF optical fibers 1020-1 through 1020-N. MC-SMF optical fiber 1010 is attached (e.g., coupled) to a first end of MC-SMF to SMF connector (“connector”) 1030 and SMF optical fibers 1020-1 through 1020-N are attached (e.g., coupled) to a second end of connector 1030. MC-SMF optical fiber 1010 can be connected to multiple standard SMF optical fibers 1020-1 through 1020-N using any suitable connector 1030 for standard connection. An example of MC-SMF optical fiber 1010 including cladding layer 1013 and multiple inner cores 1014 is shown with reference to FIG. 10B (e.g., similar to MC-SMF optical fiber 840-1 of FIGS. 8A-8B). An example of SMF optical fiber 1020-1 including cladding layer 1023 and inner core 1024 is shown with reference to FIG. 10C.

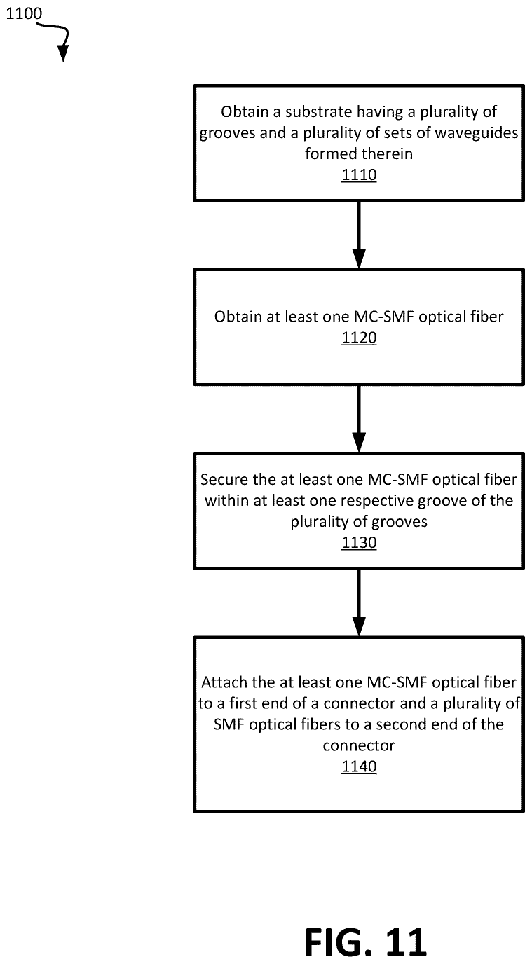

FIG. 11 is a flowchart of a method to enable dense waveguide to optical fiber edge coupling, according to some embodiments. At block 1110, a substrate having a plurality of grooves and a plurality of sets of waveguides is obtained. In some embodiments, obtaining the substrate includes forming at least one of: the plurality of grooves within the substrate, or the plurality of sets of waveguides within the substrate. In some embodiments, the plurality of grooves includes a first groove separated from a second groove by a pitch that ranges between about 100 μm to about 150 μm.

At block 1120, at least one MC-SMF optical fiber is obtained. In some embodiments, obtaining the at least one MC-SMF optical fiber includes forming the plurality of inner cores within the cladding layer. In some embodiments, the cladding layer has a diameter that ranges between about 100 μm to about 150 μm. In some embodiments, the plurality of inner cores is arranged within the cladding layer in an approximately linear configuration. In some embodiments, the plurality of inner cores is arranged within the cladding layer in a non-linear configuration. In some embodiments, the non-linear configuration corresponds to a hexagonal cross-sectional shape.

At block 1130, the at least one MC-SMF optical fiber is secured within at least one respective groove of the plurality of grooves. In some embodiments, securing the at least one MC-SMF optical fiber within the at least one respective groove of the plurality of grooves comprises using an adhesive (e.g., glue) to secure the at least one MC-SMF optical fiber into the at least one respective groove of the plurality of grooves.

In some embodiments, a second substrate is formed on the first substrate. The second substrate can have a second plurality of grooves and a second plurality of sets of waveguides formed therein, and each groove of the second plurality of grooves can correspond to a respective set of waveguides of the second plurality of sets of waveguides. In some embodiments, forming the second substrate on the first substrate includes bonding the second substrate to the first substrate via a bonding layer. In some embodiments, at least one MC-SMF optical fiber is secured within at least one respective groove of the second plurality of grooves.

At block 1140, the at least one MC-SMF optical fiber is attached to a first end of a connector and a plurality of SMF optical fibers is attached to a second end of the connector. Further details regarding blocks 1110-1140 are described above with reference to FIGS. 7A-10C.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
a substrate having a plurality of grooves and a plurality of sets of waveguides formed therein, wherein each groove of the plurality of grooves corresponds to a respective set of waveguides of the plurality of sets of waveguides; and
at least one multicore single-mode fiber (MC-SMF) optical fiber secured within at least one respective groove of the plurality of grooves, wherein the at least one MC-SMF optical fiber comprises a plurality of inner cores disposed within a cladding layer.

2. The system of claim 1, wherein the plurality of grooves comprises a first groove separated from a second groove by a pitch that ranges between about 100 micrometers (μm) to about 150 μm.

3. The system of claim 1, wherein the cladding layer has a diameter that ranges between about 100 micrometers (μm) to about 150 μm.

4. The system of claim 1, wherein each inner core of the plurality of inner cores has a diameter that ranges between about 6 μm to about 10 μm.

5. The system of claim 1, wherein the plurality of inner cores is arranged within the cladding layer in an approximately linear configuration.

6. The system of claim 5, wherein the at least one MC-SMF optical fiber comprises at least five inner cores.

7. The system of claim 5, wherein the plurality of inner cores comprises a first inner core and a second inner core separated by a distance that ranges between about 15 μm to about 25 μm.

8. The system of claim 1, wherein the plurality of inner cores is arranged within the cladding layer in a non-linear configuration.

9. The system of claim 8, wherein the at least one MC-SMF optical fiber comprises at least 19 inner cores.

10. The system of claim 1, further comprising a second substrate disposed on the substrate and having a second plurality of grooves and a second plurality of sets of waveguides formed therein, wherein each groove of the second plurality of grooves corresponds to a respective set of waveguides of the second plurality of sets of waveguides.

11. The system of claim 1, further comprising:
a plurality of single-mode fiber (SMF) optical fibers; and
a connector having a first end attached to the at least one MC-SMF optical fiber and a second end attached to the plurality of SMF optical fibers.

12. A method comprising:
obtaining a substrate having a plurality of grooves and a plurality of sets of waveguides formed therein, wherein each groove of the plurality of grooves corresponds to a respective set of waveguides of the plurality of sets of waveguides;
obtaining at least one multicore single-mode fiber (MC-SMF) optical fiber comprising a plurality of inner cores disposed within a cladding layer; and
securing the at least on MC-SMF optical fiber within at least one respective groove of the plurality of grooves.

13. The method of claim 12, wherein obtaining the substrate comprises forming at least one of: the plurality of grooves within the substrate, or the plurality of sets of waveguides within the substrate.

14. The method of claim 12, wherein obtaining the at least one MC-SMF optical fiber comprises forming the plurality of inner cores within the cladding layer.

15. The method of claim 12, wherein the plurality of grooves comprises a first groove separated from a second groove by a pitch that ranges between about 100 micrometers (μm) to about 150 μm.

16. The method of claim 12, wherein the cladding layer has a diameter that ranges between about 100 micrometers (μm) to about 150 μm, and wherein each inner core of the plurality of inner cores has a diameter that ranges between about 6 μm to about 10 μm.

17. The method of claim 12, wherein the plurality of inner cores is arranged within the cladding layer in an approximately linear configuration.

18. The method of claim 12, wherein the plurality of inner cores is arranged within the cladding layer in a non-linear configuration.

19. The method of claim 12, further comprising forming, on the substrate, a second substrate having a second plurality of grooves and a second plurality of sets of waveguides formed therein, wherein each groove of the second plurality of grooves corresponds to a respective set of waveguides of the second plurality of sets of waveguides.

20. The method of claim 12, further comprising:
attaching the at least one MC-SMF optical fiber to a first end of connector; and
attaching a plurality of single-mode fiber (SMF) optical fibers to a second end of the connector.
